(19) United States
(12) Patent Application Publication
(10) Pub. No.: US 2004/0174275 A1
(43) Pub. Date: Sep. 9, 2004

(54) Method for the display of cartographic information on an aeroplane screen

(76) Inventor: Erick Coppolino, St Medard En Jalles (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/479,407

(22) PCT Filed: Jun. 28, 2003
(86) PCT No.: PCT/FR02/02260

(30) Foreign Application Priority Data
Jun. 29, 2001 (FR) 01/08667

(51) Int. Cl. G08B 21/00; G05D 1/00

(52) U.S. Cl. 340/945; 701/3

(57) ABSTRACT

The invention relates to the field of methods of displaying cartographic information on aircraft screen.

This is a method of display, on an aircraft screen, of several windows (2D5, 3D, VP, HP) each representing a distinct aspect of the terrain of a scene overflown by the aircraft, characterized in that the method can present a simultaneous display of at least three intercorrelated windows which are, a 2D5 window representing a plan view overlaid with relief information, a 3D window representing a three-dimensional view, a profile window (VP) representing a profile view.

The invention can in particular be applied to a specific screen dedicated to on-helicopter mission conduct.

The invention relates to the field of methods of displaying cartographic information on aircraft screen.

The cartographic information displayed allows the pilot of an aircraft on the one hand to know whereabouts he is located and on the other hand to ascertain the environment of his whereabouts. Throughout the subsequent text, unless mentioned to the contrary, the term “pilot” refers either to the pilot of the aircraft if he is the one looking at the screen displaying the cartographic information or to any other operator onboard the aircraft whose function would be to look at the screen displaying the cartographic information. The cartographic information displayed allows the pilot of the aircraft to address his constant concern which consists in always having the means of managing his environment. To aid the pilot to manage his environment correctly, the ergonomic nature of the cartographic information displayed is important since it allows the pilot to have available a maximum of information that can be assimilated with a minimum of effort, thereby making it possible to improve the quality of piloting of the aircraft with constant hardware and human resources, while complying with the safety directives.

In order to enhance the ergonomics of the cartographic information displayed, the invention proposes the display of three windows each representing an aspect of the terrain of a scene and being intercorrelated. The various aspects represented are chosen in such a way that their simultaneous and correlated presentation, on a screen, allows the pilot's gaze to embrace all the essential cartographic information that he needs in order to get a clear and complete representation of the terrain that he is overflying or else that he intends to overfly and to do so even in case of poor conditions of visibility or of brightness, for example in the case of degraded meteorological conditions or during a night flight.

According to the invention, there is provided a method of display, on an aircraft screen, of several windows each representing a distinct aspect of the terrain of a scene overflown by the aircraft, characterized in that the method can present a simultaneous display of at least three intercorrelated windows which are: a 2D5 window representing a plan view overlaid with relief information, a 3D window representing a three-dimensional view, a profile window representing a profile view.

According to the invention, more precisely, there is also provided a method of display, on an aircraft screen, of several windows each comprising a cartographic image representing a distinct aspect of the terrain of a scene overflown by the aircraft, characterized in that the method can present a simultaneous display of at least three windows, a 2D5 window whose cartographic image represents a plan view of the terrain, said view being two-dimensional and overlaid by a shading representative of the relief of the terrain, a 3D window whose cartographic image represents a three-dimensional view of the terrain along a favored direction, a profile window whose cartographic image represents a profile view of the terrain, said view being two-dimensional and representative of the relief of the terrain over a band parallel to a favored axis, and in that, on the one hand the position of the viewpoint is the same for the views of the three windows, and on the other hand the orientation of the viewpoint is the same at least for the views of the 2D5 and profile windows.

The invention will be better understood and other features and advantages will become apparent with the aid of the description hereinbelow and of the appended drawings, given by way of examples, where:

FIG. 1 diagrammatically represents an exemplary correlation between the 2D5 view and the 3D view, for which the orientation of the viewpoint for the 2D5 and 3D windows is different;

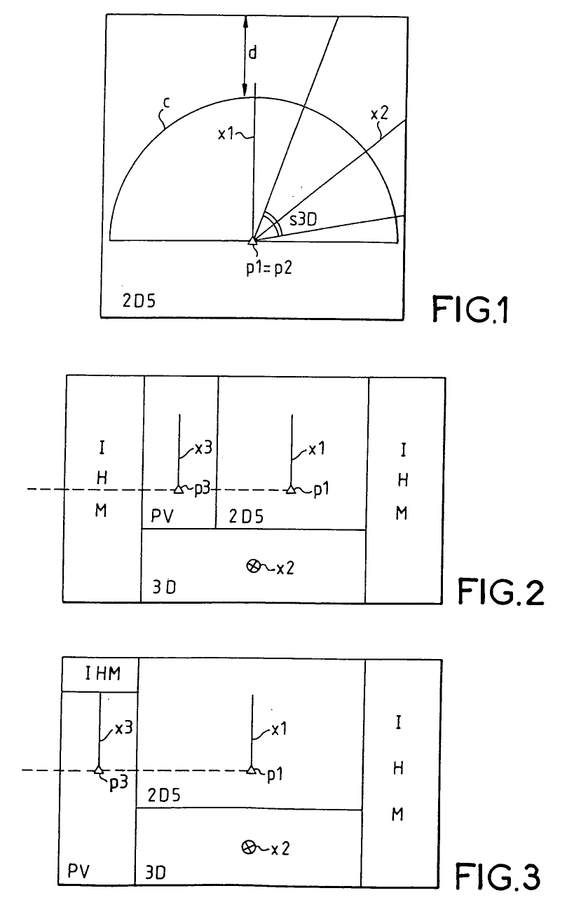

FIGS. 2 and 3 diagrammatically represent preferred examples of display of windows by the method according to the invention;

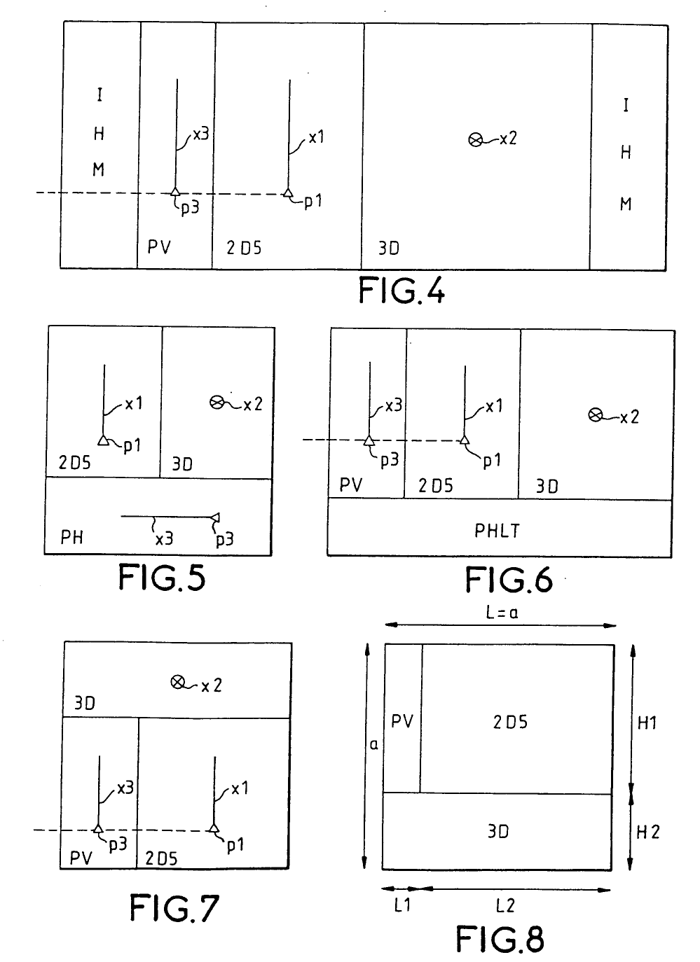

FIGS. 4 to 7 diagrammatically represent other examples of display of windows by the method according to the invention;

FIG. 8 diagrammatically represents a preferred example of display of windows by the method according to the invention, depicting the relative dimensions of the various windows.

The cartographic information displayed on the screen represents various aspects of the terrain overflown by the aircraft. Each of the aspects is represented in a window, the content of each window may thus be called a “map” within the general meaning of the term. The content of each window corresponds to a high-quality digital map which is the equivalent of the conventionally known paper maps. The digital maps, designed for aircraft, are for example to the 1:250000 scale. Certain cartographic information intended to be displayed on the screen, such as in particular the planimetry information, may be stored onboard the aircraft, in one or more memories of a cartographic system, either in the form of images, or in vector form.

The cartographic system containing the cartographic information intended to be displayed on the screen may be linked for example to one or more other devices that the aircraft may advantageously comprise, including, a navigation or radionavigation system, a data link system, an head-up display, a telemeter, an interface allowing voice control on the part of the pilot.

The cartographic information intended to be displayed on the screen is, mostly, distributed in the three windows displayed on the screen and intercorrelated. These three screens, presented and described hereinbelow, are called the 2D5 window, the 3D window and the profile window respectively. Each of said windows represents an aspect of the terrain of a scene overflown by the aircraft or intended to be overflown by the aircraft. In the detailed explanation of the windows which follows, said terrain will be called, for the sake of simplicity, the terrain.

The 2D5 window represents a plan view of the terrain, said plan view being overlaid with relief information; hence the name 2D5, that can be understood as “two and a half dimensions” insofar as the cartographic image contained in the 2D5 window contains, for the terrain part represented, more information than a two-dimensional map, but less information than a three-dimensional map. Preferably, the cartographic image of the 2D5 window represents a plan view of the terrain, said view being two-dimensional and overlaid with a shading representative of the relief of the terrain. Said shading conveys the relief information in a manner which is more legible for the pilot than the conventional level curves. Said shading preferably affects only the luminance of the various hues displayed in the window. The cartographic image of the 2D5 window affords the pilot a possibility of anticipation with respect to the relief of the terrain and with respect to potential threats for the aircraft, that is not always made possible by the cartographic image contained in the 3D window.

The 3D window represents a three-dimensional view of the terrain. Preferably, the cartographic image of the 3D window represents a three-dimensional view of the terrain along a favored direction. The cartographic image of the 3D window then represents an angular sector of the cartographic image of the 2D5 window. Specifically, when the cartographic image of the 3D window represents a wider angular sector than an angle of 120 degrees, the impression produced on the pilot is unpleasant, this is why the cartographic image of the 3D window preferably corresponds to an angular sector of the cartographic image of the 2D5 window, the three-dimensional view then being along a favored direction which is the interior bisector of the angular sector. This favored direction, if it were represented, would correspond to a straight line in the plane of the cartographic image of the 2D5 window. The cartographic image of the 3D window, depending on whether or not the visual field is masked by an obstacle, for example a mountain, does not or does allow anticipation on the part of the pilot. Conversely, in very open terrain, the cartographic image of the 3D window may allow the pilot to see further than the cartographic image of the 2D5 window. The three-dimensional view is very useful for the pilot since it is either a valuable aid to piloting under conditions of degraded visibility, for example meteorological conditions of the fog type or indeed night flight, or a replay of the actual conditions allowing anticipation for the pilot of what the degraded conditions of visibility will be when he overflies the terrain at some later moment.

The profile window represents a profile view of the terrain. Preferably, the cartographic image of the profile window represents a profile view of the terrain, said view being two-dimensional and representative of the relief of the terrain over a band parallel to a favored axis. This favored axis, situated at equal distance from each of the ends of the band which is parallel thereto, is preferably a straight line parallel to the heading of the aircraft and passing through the position of said aircraft. The relief of the terrain represented in the profile window advantageously corresponds to the upper bound on the width of the band, said width being orthogonal to the favored axis. Thus, for safety's sake at each point of the favored axis, it is the relief of the highest point of the zone straddling the favored axis and encompassing the favored axis which is indicated to the pilot. In other less advantageous embodiments, the profile view of the terrain is representative of the terrain on the favored axis only or on a set of axes being mutually parallel and comprising the favored axis. These embodiments are less advantageous since the safety margins for the pilot are not as big. The cartographic image of the profile window has, on the radar means often used by fast aircraft of the airplane type, the advantage of being able to be obtained discreetly, that is to say by means that do not reveal the presence of said aircraft to potential threats, this not of course being the case with said radar means. The cartographic image of the profile window represents a kind of short-term terrain section.

The aircraft using the method of display according to the invention is preferably a slow aircraft of the helicopter type. However, the aircraft may also be a fast aircraft of the airplane type. Both for the helicopter and for the airplane, the cartographic background displayed is similar, on the other hand the associated tools may be different. For example, an airplane possesses radar means having terrain functions which render the presence of the profile window representing a short-term section through the terrain less crucial.

In the aircraft, the method of display according to the invention displays cartographic information in the three windows described hereinabove, namely the 2D5 window, the 3D window, the profile window. These three windows are preferably displayed on one single specific screen which is dedicated to mission conduct. However, these three windows could be displayed on any conventional screen or screens of an aircraft, for example on one of the ND, PFD and MCDU screens (the initials standing respectively for “navigation display”, “primary flight display” and “multipurpose control display unit”), or else on several neighboring or adjoining screens. The screen dedicated to mission conduct is preferably almost vertical, that is to say slightly inclined only with respect to the vertical, for example some ten degrees, so as to limit the tilting movements of the pilot's head and avoid luminous reflections due to the sun.

Preferably, the method of display according to the invention comprises at least two modes of operation, a navigation mode in which the position of the viewpoint in the 2D5 window is vertically offcentered with respect to the 2D5 window and in which the orientation of the viewpoint in the 2D5 window corresponds to the heading of the aircraft, as well as a management mode in which the position of the viewpoint in the 2D5 window is centered with respect to the 2D5 window and in which the orientation of the viewpoint in the 2D5 window corresponds to a fixed direction independent of the heading of the aircraft, for example the direction of North. The navigation mode is a “short-term” mode in which the terrain of the scene displayed is overflown by the aircraft or is about to be overflown by the aircraft soon. The management mode is a “medium-term” mode, a kind of preview in which the pilot or another operator scrolls through the landscape in advance, sometimes appreciably before the aircraft arrives above it. Preferably, the 2D5 and 3D windows may be used either in navigation mode or in management mode, while the profile window can be used in navigation mode only. The possibility of simultaneous display of the three correlated windows is therefore required only in navigation mode for the method of display according to the invention.

An important characteristic of the method of display according to the invention is that the windows displayed on the screen are at least three in number, namely the 2D5, 3D and profile windows. Another important characteristic of the method of display according to the invention is that these three windows are intercorrelated. Each of these windows representing a cartographic image, has a viewpoint position as well as a viewpoint orientation. During a rotation of the cartographic image of a window, the position of the viewpoint of said window is the point about which the cartographic image of said window turns. During a translation of the cartographic image of a window, the orientation of the viewpoint of said window is the direction along which the cartographic image of said window is translated. Since these three windows are correlated, there exists a determined relation between the three inter-corresponding viewpoint positions as well as between the three inter-corresponding viewpoint orientations. Said windows are necessarily correlated at the terrain level, preferably correlated at the targets level. The correlation of said windows at the level of the other objects represented is beneficial but optional.

Preferably, the position of the viewpoints is the same for the views of the three windows, it is the position of the aircraft in navigation mode. Preferably, the orientation of the viewpoint is the same for the views of the 2D5 and profile windows, it is the heading of the aircraft in navigation mode, the orientation of the viewpoint of the view of the 3D window possibly being different, but it is then preferably portrayed on the view of the 2D5 window, for example by an angular sector which is drawn on the 2D5 view and which represents the angular sector embraced by the three-dimensional view of the 3D window.

FIG. 1 diagrammatically represents an exemplary correlation between the 2D5 view and the 3D view, in which the viewpoint orientations are not the same for the views of the 2D5 and 3D windows. The window represented is the 2D5 window. The mode is the navigation mode. Let p1 be the position of the aircraft, x1 the heading of the aircraft. The point p1 is situated in the lower part of the 2D5 window as shown by the presence of the gap d, C being a semicircle of the points equidistant from the point p1. The angular sector of the three-dimensional view of the 3D window is represented in the 2D5 window by the sector s3D. The axis x2 is the bisector of the angular sector s3D, it represents the orientation of the viewpoint in the 3D window. However, preferably, the orientation of the viewpoint is the same for the views of the three windows, namely the 2D5, 3D and profile windows; in this case, the axis x1 would be the interior bisector of the angular sector s3D and would coincide with the axis x2 which axis x2 would then preferably be vertical in FIG. 1.

Consider the screen orientation determined with respect to the user who is looking at the screen on which the cartographic information is displayed and who will usually be the pilot of the aircraft. The 2D5 window is preferably either rectangular of large vertical dimension or square. The profile window is preferably rectangular of large vertical dimension and advantageously situated opposite and alongside the 2D5 window. The 3D window is preferably rectangular of large horizontal dimension and advantageously situated on the one hand opposite the 2D5 window and on the other hand above or below the 2D5 window. The rectangular nature of large vertical dimension of all or some of the windows comprising a cartographic image, in particular the 2D5 window, the 3D window and the profile window, makes it possible in navigation mode to favor the terrain view situated in front of the aircraft, thus allowing better anticipation by the pilot. The windows are advantageously situated opposite one another, they may also however exhibit overhangs with respect to one another.

Preferably, the 3D window is centered with respect to the horizontal dimension of the screen. A three-dimensional view of the off-centered 3D window is conceivable but not recommended since this off-centered nature disturbs the pilot slightly when he is looking at the screen.

On each side of the assembly consisting of the three windows comprising cartographic images and respectively representing distinct aspects of the terrain, the method can advantageously display one or more man-machine interface windows. These man-machine interface windows may also be replaced with buttons situated outside the screen.

Preferably, the orientation of the screen being determined with respect to the user, the position of the viewpoint is, at equal height on the screen, in the 2D5 and profile windows. Moreover, the lines respectively representing the orientation of the viewpoint in the 2D5 and profile windows are advantageously parallel on the screen. Thus, the pilot is capable of making a direct and instantaneous correlation between the views of the 2D5 and profile windows. Out of all the FIGS. 2 to 7 described hereinabove, only FIG. 5 does not allow this direct and instantaneous correlation. The relative arrangement of the windows represented in FIG. 5 is consequently the least good, although still nonetheless conceivable. The straight lines representing the orientation of the viewpoint in the 2D5 and profile windows are preferably vertical on the screen.

FIGS. 2 and 3 diagrammatically represent preferred examples of the display of windows by the method according to the invention. FIGS. 4 to 7 diagrammatically represent other examples of display of windows by the method according to the invention. The 2D5 window, the 3D window and the profile window are represented in all of FIGS. 2 to 7, the profile window being dubbed VP when it is vertical or HP when it is horizontal. The relative arrangement, preferred or otherwise, of all of these windows is depicted in these FIGS. 2 to 7 whereas the preferred relative dimensions of the various windows are depicted in FIG. 8. MMI windows, that is to say man-machine interface windows, are also represented in certain figures only, for the sake of simplicity, although all the arrangements represented in FIGS. 2 to 7 may comprise same. The viewpoint positions in the 2D5, 3D and profile windows are respectively the points p1, p2 and p3, while the viewpoint orientations in the 2D5, 3D and profile windows are respectively the axes x1, x2 and x3. The axis x2 is perpendicular to the plane of FIGS. 2 to 7, while the point p2 is situated above the plane of FIGS. 2 to 7 and consequently is not represented in said figures. In all of FIGS. 2 to 7, the viewpoint positions as well as the viewpoint orientations are the same for the 2D5, 3D and profile windows. By way of example, the projection of the point p2 onto the 2D5 window would give the point p1 and the projection of the axis x3 onto the 3D window would give the axis x2. All the arrangements representing arrangements that are symmetrical, with respect to a vertical axis of symmetry, with the arrangements represented in FIGS. 2 to 7 are equivalent to the arrangements to which they are symmetrical and are consequently included explicitly in the following description of FIGS. 2 to 7.

In FIG. 2, the profile window VP is situated on the left of the 2D5 window, while the 3D window is situated under the 2D5 window and under the profile window VP. Two MMI windows are situated on either side of the assembly consisting of the windows comprising a cartographic image, namely the 2D5, 3D and profile VP windows.

In FIG. 3, the profile window VP is situated on the left of the 2D5 window and of the 3D window, while the 3D window is situated under the 2D5 window. An MMI window is situated on the right of the assembly consisting of the windows comprising a cartographic image, namely the 2D5, 3D and profile VP windows. Another MMI window is situated above the profile window VP as well as on the left of the 2D5 window.

In FIG. 4, the vertical field of the windows and consequently the pilot's anticipation capability are improved but to the detriment of the overall ergonomics which is optimal for arrangements such as those represented in FIGS. 2 and 3. An MMI window, the profile window VP, the 2D5 window, the 3D window, another MMI window follow one another from left to right.

In FIG. 5, the profile window is a horizontal profile window HP. The 2D5 window is situated on the left of the 3D window, while the profile window HP is situated under the assembly consisting of the 2D5 and 3D windows. This arrangement is the least good of those represented in FIGS. 2 to 7, since it does not allow direct and instantaneous correlation between the views of the 2D5 and profile HP windows, on the part of the pilot.

In FIG. 6, the profile window VP, the 2D5 window, the 3D window, another window called LTHP follow one another from left to right. The LTHP window is a long-term horizontal profile window, it represents a horizontal sectional view of the terrain, which terrain remains stationary on the screen while a cursor representing the position of the aircraft moves within the LTHP window of the screen according to the motion of the aircraft.

In FIG. 7, the profile window VP is situated on the left of the 2D5 window, while the 3D window is situated above the 2D5 window and above the profile window VP.

Preferably, the three windows are made adjoining in such as way as to form substantially a square of side a, the 2D5 window forming substantially a rectangle of large horizontal dimension 5a/6 and of small vertical dimension 2a/3, the profile window forming substantially a rectangle of dimensions 2a/3 by a/6, the 3D window forming substantially a rectangle of dimensions a by a/3. An arrangement of windows of such a size is advantageous insofar as the 2D5 window possesses the largest surface area for being able to represent a large amount of cartographic information for a considerable extent of terrain, as the 3D window exhibits an angular sector that is substantially wider in bearing than in elevation, this being preferred by the pilot, and as the profile window occupies only the relatively small surface area necessary for the representation of its not very dense cartographic information: the ratio between density of cartographic information displayed and used surface area of screen is then fairly optimized. An example of an arrangement of windows of such a size is represented in FIG. 8.

FIG. 8 diagrammatically represents a preferred example of display of windows by the method according to the invention, depicting the relative dimensions of the various windows. Together, the 2D5, 3D and profile VP windows form a square of side a. The width L1 of the profile window VP equals a/6 while its height H1 equals 2a/3. The width L2 of the profile window VP equals 5a/6 while its height H1 equals 2a/3. The width L3 of the profile window VP equals a while its height H2 equals a/3.

The preferred shape of all the windows used is preferably rectangular and square since this is both the most usual and the most ergonomic shape for the representation of cartographic information. However other shapes are conceivable insofar as they do not disturb or do not excessively disturb the representation that the pilot can get of the terrain by looking at the cartographic images represented in the various windows.

Preferably, when the terrain is oriented along the heading of the aircraft, that is to say in navigation mode, on the one hand the illumination of the 2D5 view is artificial and fixed with respect to the screen regardless of the changes of orientation of the aircraft, and on the other hand the illumination of the 3D view is realistic and variable with respect to the screen in such a way as to take account of the alterations in the actual position of the sun as a function of the changes of orientation of the aircraft. The orientation of the screen being determined with respect to the user, the illumination of the 2D5 view advantageously comprises a point source situated above and on the left of the upper left corner of said 2D5 view. The illumination can also, optionally, comprise another source which is diffuse and which is situated at the zenith of said 2D5 view. These preferred but optional embodiments exhibit a double advantage. On the one hand the pilot is at no risk of confusing the hollows and the bumps of the terrain overflown, this unfortunately possibly becoming the case when the illumination of the 2D5 window is realistic and variable and when the aircraft is moving rather more in a Southerly heading, especially in case of pilot fatigue. On the other hand the realistic and variable illumination is more suited to the view of the 3D window, since it corresponds better to the actual landscape such as can be seen by the pilot by looking through the cockpit of the aircraft under correct meteorological conditions.

1. A method of display, on an aircraft screen, of several windows (2D5, 3D, VP, HP) each representing a distinct aspect of the terrain of a scene overflown by the aircraft, characterized in that the method can present a simultaneous display of at least three intercorrelated windows which are, a 2D5 window representing a plan view overlaid with relief information, a 3D window representing a three-dimensional view, a profile window (VP, HP) representing a profile view.

2. A method of display, on an aircraft screen, of several windows (2D5, 3D, VP, HP) each comprising a cartographic image representing a distinct aspect of the terrain of a scene overflown by the aircraft,
characterized in that
the method can present a simultaneous display of at least three windows,
a 2D5 window whose cartographic image represents a plan view of the terrain, said view being two-dimensional and overlaid by a shading representative of the relief of the terrain,
a 3D window whose cartographic image represents a three-dimensional view of the terrain along a favored direction (x2),
a profile window (VP, HP) whose cartographic image represents a profile view of the terrain, said view being two-dimensional and representative of the relief of the terrain over a band parallel to the favored axis (x3),
and in that,
on the one hand the position (p1, p2, p3) of the viewpoint is the same for the views of the three windows,
and on the other hand the orientation (x1, x3) of the viewpoint is the same at least for the views of the 2D5 and profile windows.

3. The method of display as claimed in claim 2, characterized in that the relief of the terrain represented in the profile window (VP, HP) corresponds to the upper bound on the width of the band, said width being orthogonal to the favored axis (x3).

4. The method of display as claimed in any one of the preceding claims, characterized in that the orientation (x1, x2, x3) of the viewpoint is the same for the views of the three windows.

5. The method of display as claimed in any one of the preceding claims, characterized in that, when the terrain is oriented along the heading of the aircraft, on the one hand the illumination of the 2D5 view is artificial and fixed with respect to the screen regardless of the changes of orientation of the aircraft, and on the other hand the illumination of the 3D view is realistic and variable with respect to the screen in such a way as to take account of the alterations of the actual position of the sun as a function of the changes of orientation of the aircraft.

6. The method of display as claimed in claim 5, characterized in that, the orientation of the screen being determined with respect to the user, the illumination of the 2D5 view comprises a point source situated above and to the left of the upper left corner of said 2D5 view.

7. The method of display as claimed in claim 6, characterized in that, the orientation of the screen being determined with respect to the user, the illumination of the 2D5 view also comprises a diffuse source situated at the zenith of said 2D5 view.

8. The method of display as claimed in any one of the preceding claims, characterized in that, the orientation of the screen being determined with respect to the user, the 2D5 window is rectangular of large vertical dimension or square.

9. The method of display as claimed in any one of the preceding claims, characterized in that, the orientation of the screen being determined with respect to the user, the profile window (VP) is rectangular of large vertical dimension and situated opposite and alongside the 2D5 window.

10. The method of display as claimed in any one of the preceding claims, characterized in that, the orientation of the screen being determined with respect to the user, the 3D window is rectangular of large horizontal dimension and situated on the one hand opposite the 2D5 window and on the other hand above or below the 2D5 window.

11. The method of display as claimed in claims 9 and 10, characterized in that the three windows are made adjoining in such as way as to form substantially a square of side a, the 2D5 window forming substantially a rectangle of large horizontal dimension 5a/6 and of small vertical dimension 2a/3, the profile window (VP) forming substantially a rectangle of dimensions 2a/3 by a/6, the 3D window forming substantially a rectangle of dimensions a by a/3.

12. The method of display as claimed in any one of the preceding claims, characterized in that, the orientation of the screen being determined with respect to the user, the 3D window is centered with respect to the horizontal dimension of the screen.

13. The method of display as claimed in any one of the preceding claims, characterized in that the method comprises at least two modes of operation, a navigation mode in which the position (p1) of the viewpoint in the 2D5 window is vertically offcentered with respect to the 2D5 window and in which the orientation (x1) of the viewpoint in the 2D5 window corresponds to the heading of the aircraft, as well as a management mode in which the position (p1) of the viewpoint in the 2D5 window is centered with respect to the 2D5 window and in which the orientation (x1) of the viewpoint in the 2D5 window corresponds to a fixed direction independent of the heading of the aircraft.

14. The method of display as claimed in any one of the preceding claims, characterized in that, on each side of the assembly consisting of the three windows (2D5, 3D, VP) respectively representing distinct aspects of the terrain, the method can display a man-machine interface window (MMI).

15. The method of display as claimed in any one of the preceding claims, characterized in that, the orientation of the screen being determined with respect to the user, the position (p1, p3) of the viewpoint is, at equal height on the screen, in the 2D5 and profile (VP) windows.

16. The method of display as claimed in any one of the preceding claims, characterized in that the lines (x1, x3) respectively representing the orientation of the viewpoint in the 2D5 and profile windows are parallel on the screen.

17. A screen dedicated to mission conduct, characterized in that the display on this screen is controlled by a method of display according to any one of the preceding claims.

18. A helicopter characterized in that it comprises a screen according to claim 17 or a multi-use screen whose display is controlled by a method of display according to any one of claims 1 to 16.
